(19) United States
(12) Patent Application Publication
(10) Pub. No.: US 2013/0063090 A1
(43) Pub. Date: Mar. 14, 2013

(54) BATTERY PROTECTION CIRCUIT AND BATTERY PROTECTION DEVICE, AND BATTERY PACK

(71) Applicants: Junji TAKESHITA, Tokyo (JP); Takashi Takeda, Tokyo (JP)

(72) Inventors: Junji TAKESHITA, Tokyo (JP); Takashi Takeda, Tokyo (JP)

(21) Appl. No.: 13/355,620

(22) Filed: Jan. 23, 2012

(30) Foreign Application Priority Data
Sep. 8, 2011 (JP) 2011-196388

(51) Int. Cl. H02J 7/00

(52) U.S. Cl. 320/126

(57) ABSTRACT

A battery protection circuit to protect secondary batteries coupled in parallel, includes an overdischarge detection part provided for each of the secondary batteries and to output an abnormality signal when an overdischarge is detected from a corresponding one of the secondary batteries, an overcurrent detection part provided for each of the secondary batteries and to output an abnormality signal when an overcurrent is detected from a corresponding one of the secondary batteries, and a discharge control part to prohibit a discharge of at least one secondary battery when the abnormality signal is output from at least one of the overdischarge detection part and the overcurrent detection part.

### CROSS-REFERENCE TO RELATED APPLICATIONS

This application is based upon and claims the benefit of priority of the prior Japanese Patent Application No. 2011-196388, filed on Sep. 8, 2011, the entire contents of which are incorporated herein by reference.

### TECHNICAL FIELD

The present invention relates to a battery protection circuit and a battery protection device to protect a plurality of secondary batteries connected in parallel. In addition, the present invention relates to a battery pack including the battery protection device.

### BACKGROUND ART

FIG. 1 is a diagram illustrating a conventional protection IC 190 to protect secondary batteries 201A and 201B connected in parallel. Positive electrodes of the secondary batteries 201A and 201B are connected to a power supply route 108 that connects to a load connecting terminal P+, and negative electrodes of the secondary batteries 201A and 201B are connected to a power supply route 109 that connects to a load connecting terminal P−. An external load and/or a charger, not illustrated, is/are connected to the load connecting terminals P+ and P−. In addition, a terminal 7a of the protection IC 190 is connected to the power supply route 108, and a terminal 7b of the protection IC 190 is connected to the power supply route 109.

The protection IC 190 monitors a voltage between the terminals 7a and 7b, and when the monitored voltage is normal, turns ON a transistor 1 connected to a terminal 7d, and turns ON a transistor 2 connected to a terminal 7c. Hence, the secondary batteries 201A and 201B may be charged and discharged. On the other hand, when the monitored voltage becomes a predetermined overcharge detection threshold value or greater, the protection IC 190 turns OFF the transistor 1 in order to prohibit charging of the secondary batteries 201A and 201B, and when the monitored voltage becomes less than the predetermined overcharge detection threshold value, the protection IC 190 turns ON the transistor 2 in order to prohibit discharging of the secondary batteries 201A and 201B.

However, the protection IC 190 is configured to detect an abnormality by regarding the two secondary batteries 201A and 201B that are connected in parallel as a single secondary battery, and cannot detect the abnormality of the secondary battery 201A and the secondary battery 201B independently.

On the other hand, a Japanese Laid-Open Patent Publication No. 7-22009 proposes an arrangement to independently detect an abnormality (overcharge abnormality and overdischarge abnormality) of two systems of secondary batteries that are connected in parallel.

However, according to the technique proposed in the Japanese Laid-Open Patent Publication No. 7-22009, only one of the two systems of secondary batteries that are connected in parallel, from which the overcharge or overdischarge abnormality is detected, may be protected. For this reason, the protection of the two systems of secondary batteries that are connected in parallel, provided by this proposed technique, may not be sufficient.

### SUMMARY OF THE INVENTION

Accordingly, one object of the present invention is to provide a battery protection circuit and a battery protection device, and a battery pack, which may improve the protection function with respect to a plurality of secondary batteries that are connected in parallel.

According to one aspect of the present invention, a battery protection circuit may be configured to protect a plurality of secondary batteries coupled in parallel, and include an overdischarge detection part, provided for each of the plurality of secondary batteries, and configured to output an abnormality signal when an overdischarge is detected from a corresponding one of the plurality of secondary batteries; an overcurrent detection part, provided for each of the plurality of secondary batteries, and configured to output an abnormality signal when an overcurrent is detected from a corresponding one of the plurality of secondary batteries; and a discharge control part configured to prohibit a discharge of at least one of the plurality of secondary batteries when the abnormality signal is output from at least one of the overdischarge detection part and the overcurrent detection part.

According to one aspect of the present invention, a battery protection circuit may be configured to protect a plurality of secondary batteries coupled in parallel, and include an overcharge detection part, provided for each of the plurality of secondary batteries, and configured to output an abnormality signal when an overcharge is detected from a corresponding one of the plurality of secondary batteries; an overcurrent detection part, provided for each of the plurality of secondary batteries, and configured to output an abnormality signal when an overcurrent is detected from a corresponding one of the plurality of secondary batteries; and a charge control part configured to prohibit a charge of at least one of the plurality of secondary batteries when the abnormality signal is output from at least one of the overcharge detection part and the overcurrent detection part.

According to one aspect of the present invention, a battery protection circuit may be configured to protect a plurality of secondary batteries coupled in parallel, and include a plurality of discharge overcurrent detection parts, respectively provided for the plurality of secondary batteries, and each configured to output an abnormality signal when a discharge overcurrent is detected from a corresponding one of the plurality of secondary batteries; and a discharge control part configured to prohibit a discharge of all of the plurality of secondary batteries when the abnormality signal is output from at least one of the plurality of discharge overcurrent detection parts.

According to one aspect of the present invention, a battery protection circuit may be configured to protect a plurality of secondary batteries coupled in parallel, and include a plurality of overdischarge detection parts, respectively provided for the plurality of secondary batteries, and each configured to output an abnormality signal when an overdischarge is detected from a corresponding one of the plurality of secondary batteries; and a discharge control part configured to prohibit a discharge of all of the plurality of secondary batteries when the abnormality signal is output from at least one of the plurality of overdischarge detection parts.

According to one aspect of the present invention, a battery protection circuit may be configured to protect a plurality of secondary batteries coupled in parallel, and include a plurality of charge overcurrent detection parts, respectively provided for the plurality of secondary batteries, and each configured to output an abnormality signal when a charge overcurrent is detected from a corresponding one of the plurality of secondary batteries; and a charge control part configured to prohibit a charge of all of the plurality of secondary batteries when the abnormality signal is output from at least one of the plurality of charge overcurrent detection parts.

According to one aspect of the present invention, a battery protection circuit may be configured to protect a plurality of secondary batteries coupled in parallel, and include a plurality of overcharge detection parts, respectively provided for the plurality of secondary batteries, and each configured to output an abnormality signal when an overcharge is detected from a corresponding one of the plurality of secondary batteries; and a charge control part configured to prohibit a charge of all of the plurality of secondary batteries when the abnormality signal is output from at least one of the plurality of overcharge detection parts.

According to one aspect of the present invention, a battery protection device may include a battery protection circuit described above; and a discharge route blocking part configured to block a discharge route of a secondary battery whose discharge is prohibited by the discharge control part.

According to one aspect of the present invention, a battery protection device may include a battery protection circuit described above; and a charge route blocking part configured to block a charge route of a secondary battery whose charge is prohibited by the charge control part.

According to one aspect of the present invention, a battery pack may include a battery protection device described above; and the plurality of secondary batteries.

### BRIEF DESCRIPTION OF THE DRAWINGS

FIG. 1 is a diagram illustrating a conventional protection IC 190 to protect two secondary batteries 201A and 201B that are connected in parallel;

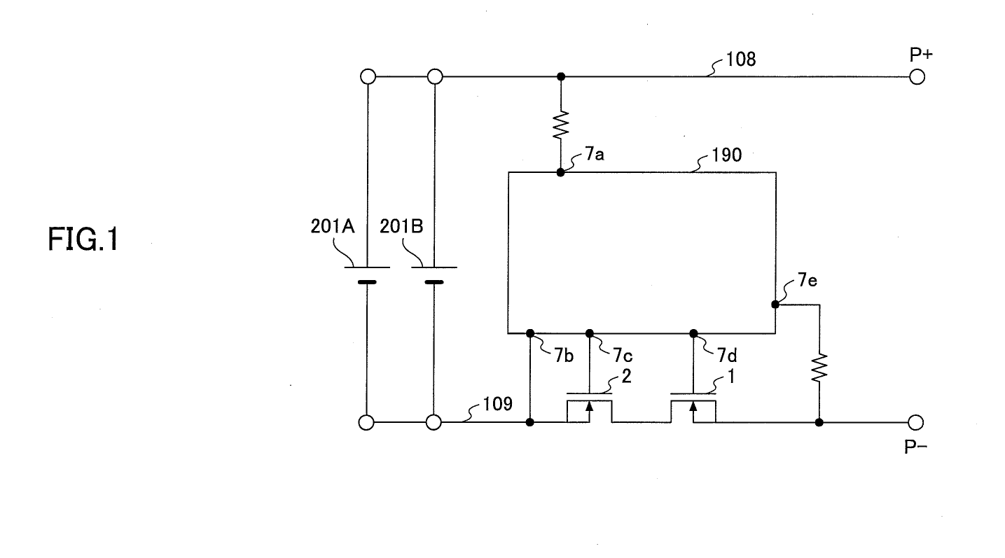

FIG. 2 is a diagram illustrating a structure of a battery pack 100 in a first embodiment of the present invention; and

FIG. 3 is a diagram illustrating a structure of a battery pack 101 in a second embodiment of the present invention.

### DETAILED DESCRIPTION OF THE PREFERRED EMBODIMENTS

A description will be given of embodiments of the present invention, by referring to the drawings.

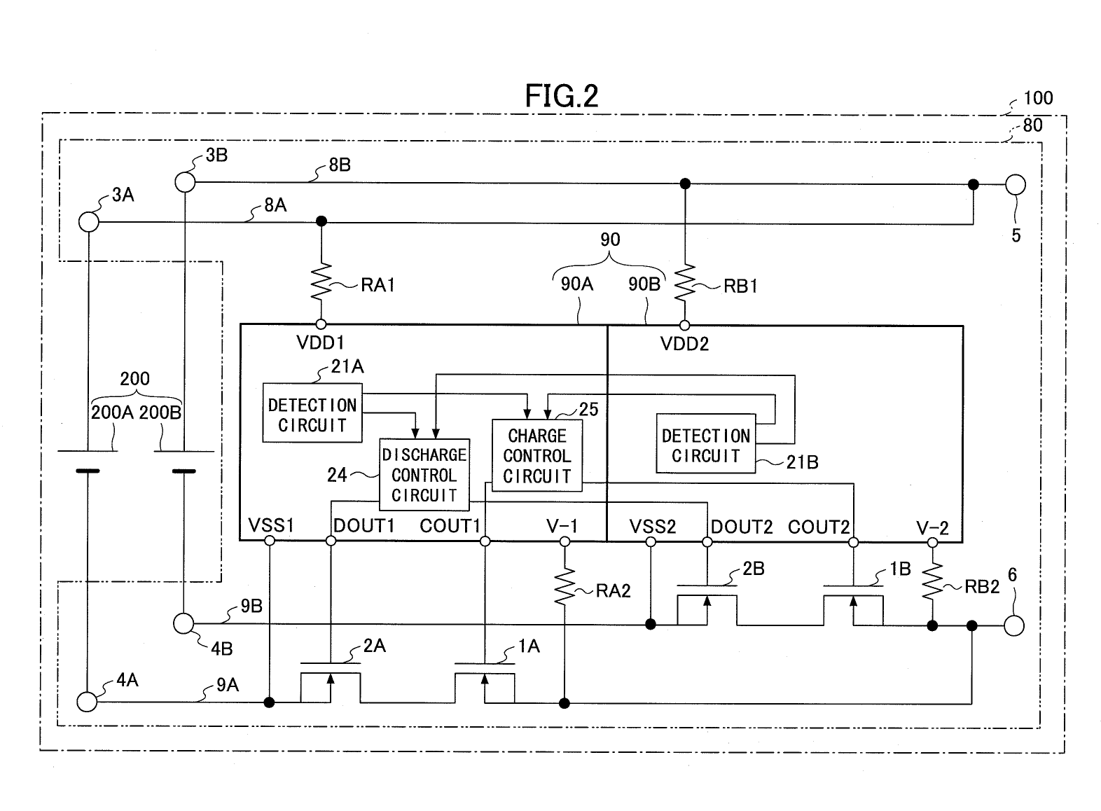

FIG. 2 is a diagram illustrating the structure of the battery pack 100 in the first embodiment of the present invention. The battery pack 100 includes a secondary battery 20 capable of supplying power to an external load, that is not illustrated and connectable to load connecting terminals 5 and 6, and a protection module 80 to protect the secondary battery 200. The battery pack 100 may be built-in within the external load or, may be externally connected to the external load. Examples of the external load may include portable terminals (mobile phones, portable game devices, PDAs, mobile personal computers, and portable music or video players), computers, head sets, and electronic equipments such as cameras.

The secondary battery 200 is chargeable by a charger, that is not illustrated and connectable to the load connecting terminals 5 and 6. Examples of the secondary battery 200 may include lithium ion batteries and nickel-metal hydride batteries. The secondary battery 200 includes two cells 200A and 200B.

The protection module 80 includes the load connecting terminal 5, the load connecting terminal 6, and cell connecting terminals 3A, 3B, 4A, and 4B. The cell connecting terminal 3A connects to the load connecting terminal 5 via a power supply route 8A, and the cell connecting terminal 3B connects to the load connecting terminal 5 via a power supply route 8B. The cell connecting terminal 4A connects to the load connecting terminal 6 via a power supply route 9A, and the cell connecting terminal 4B connects to the load connecting terminal 6 via a power supply route 9B. The cell connecting terminal 3A connects to a positive electrode of the cell 200A, and the cell connecting terminal 4A connects to a negative electrode of the cell 200A. The cell connecting terminal 3B connects to a positive electrode of the cell 200B, and the cell connecting terminal 4B connects to a negative electrode of the cell 200B.

The protection module 80 includes transistors 1A, 2A, 1B, and 2B. The transistor 1A forms a charge route blocking part to block a charge route of the cell 200A, and the transistor 2A forms a discharge route blocking part to block a discharge route of the cell 200A. The transistor 1B forms a charge route blocking part to block a charge route of the cell 200B, and the transistor 2B faults a discharge route blocking part to block a discharge route of the cell 200B. In the example illustrated in FIG. 2, the transistor 1A blocks the power supply route 9A in which a charge current of the cell 200A flows, and the transistor 2A blocks the power supply route 9A in which a discharge current of the cell 200A flows. The transistor 1B blocks the power supply route 9B in which a charge current of the cell 200B flows, and the transistor 2B blocks the power supply route 9B in which a discharge current of the cell 200B flows.

The transistors 1A and 2A form switching elements for switching the power supply route 9A between conducting and blocked states, and are inserted in series in the power supply route 9A. The transistors 1B and 2B form switching elements for switching the power supply route 9B between conducting and blocked states, and are inserted in series in the power supply route 9B.

The transistors 1A, 2A, 1B, and 2B may be formed by MOSFETs, for example. The transistor 1A is inserted in the power supply route 9A so that a forward direction of a parasitic diode of the transistor 1A matches a discharge direction of the cell 200A, and the transistor 2A is inserted in the power supply route 9A so that a forward direction of a parasitic diode of the transistor 2A matches a charge direction of the cell 200A. The transistor 1B is inserted in the power supply route 9B so that a forward direction of a parasitic diode of the transistor 1B matches a discharge direction of the cell 200B, and the transistor 2B is inserted in the power supply route 9B so that a forward direction of a parasitic diode of the transistor 2B matches a charge direction of the cell 200B. The transistors 1A, 2A, 1B, and 2B may be formed by other semiconductor elements, such as IGBTs and bipolar transistors. In addition, a diode may be added between a drain and a source (or between a collector and an emitter) of the transistors 1A, 2A, 1B, and 2B.

The protection module 80 includes a protection IC 90. The protection IC 90 is formed by an integrated circuit that is powered by the secondary battery 200 and protects the secondary battery 200. The protection IC 90 includes two chips, namely, a protection IC 90A and a protection IC 90B.

A detection circuit 21A of the protection IC 90A detects a voltage between a terminal VDD1 and a terminal VSS1 of the protection IC 90A, in order to monitor a battery voltage (cell voltage) of the cell 200A. Similarly, a detection circuit 21B of the protection IC 90B detects a voltage between a terminal VDD2 and a terminal VSS2 of the protection IC 90B, in order to monitor a battery voltage (cell voltage) of the cell 200B. The terminal VDD1 and the terminal VSS1 form power terminals of the protection IC 90A, and the terminal VDD2 and the terminal VSS2 form power terminals of the protection IC 90B.

The terminal VDD1 forms a positive power terminal connected to the power supply route 8A via a resistor RA1, and the terminal VSS1 forms a negative power terminal connected to the power supply route 9A between the cell connecting terminal 4A and the transistors 1A and 2A. The terminal VDD2 forms a positive power terminal connected to the power supply route 8B via a resistor RB1, and the terminal VSS2 forms a negative power terminal connected to the power supply route 9B between the cell connecting terminal 4B and the transistors 1B and 2B. The resistor RA1 forms a current limiting resistor to prevent an overcurrent from flowing to the terminal VDD1, and the resistor RB1 forms a current limiting resistor to prevent an overcurrent from flowing to the terminal VDD2.

In addition, the detection circuit 21A detects a voltage between a terminal V-1 of the protection IC 90A and the terminal VSS1, in order to monitor a negative terminal voltage VAP− between the load connecting terminal 6 and the cell connecting terminal 4A. In other words, the negative terminal voltage VAP− corresponds to a terminal voltage of the load connecting terminal 6 with respect to the cell connecting terminal 4A. Similarly, the detection circuit 21B detects a voltage between a terminal V-2 of the protection IC 90B and the terminal VSS2, in order to monitor a negative terminal voltage VBP− between the load connecting terminal 6 and the cell connecting terminal 4B. In other words, the negative terminal voltage VBP− corresponds to a terminal voltage of the load connecting terminal 6 with respect to the cell connecting terminal 4B. The terminal V-1 forms an overcurrent detection terminal for the protection IC 90A, and the terminal V-2 forms an overcurrent detection terminal for the protection IC 90B.

The terminal V-1 connects to the power supply route 9A between the load connecting terminal 6 and the transistors 1A and 2A, via a resistor RA2. The terminal V-2 connects to the power supply route 9B between the load connecting terminal 6 and the transistors 1B and 2B, via a resistor RB2. The resistor RA2 forms a current limiting resistor to prevent an overcurrent from flowing to the terminal V-1, and the resistor RB2 forms a current limiting resistor to prevent an overcurrent from flowing to the terminal V-2.

The protection IC 90 outputs a high-level signal from a terminal COUT1 of the protection IC 90A in order to turn ON the transistor 1A, and outputs a low-level signal from the terminal COUT1 in order to turn OFF the transistor 1A. The protection IC 90 permits a current to flow in the charge direction of the cell 200A in the power supply route 9A by turning ON the transistor 1A, and prohibits the current from flowing in the charge direction of the cell 200A in the power supply route 9A by turning OFF the transistor 1A. In addition, the protection IC 90 outputs a high-level signal from a terminal DOUT1 of the protection IC 90A in order to turn ON the transistor 2A, and outputs a low-level signal from the terminal DOUT1 in order to turn OFF the transistor 2A. The protection IC 90 permits a current to flow in the discharge direction of the cell 200A in the power supply route 9A by turning ON the transistor 2A, and prohibits the current from flowing in the discharge direction of the cell 200A in the power supply route 9A by turning OFF the transistor 2A.

Similarly, the protection IC 90 outputs a high-level signal from a terminal COUT2 of the protection IC 90B in order to turn ON the transistor 1B, and outputs a low-level signal from the terminal COUT2 in order to turn OFF the transistor 1B. The protection IC 90 permits a current to flow in the charge direction of the cell 200B in the power supply route 9B by turning ON the transistor 1B, and prohibits the current from flowing in the charge direction of the cell 200B in the power supply route 9B by turning OFF the transistor 1B. In addition, the protection IC 90 outputs a high-level signal from a terminal DOUT2 of the protection IC 90B in order to turn ON the transistor 2B, and outputs a low-level signal from the terminal DOUT2 in order to turn OFF the transistor 2B. The protection IC 90 permits a current to flow in the discharge direction of the cell 200B in the power supply route 9B by turning ON the transistor 2B, and prohibits the current from flowing in the discharge direction of the cell 200B in the power supply route 9B by turning OFF the transistor 2B.

The detection circuit 21A forms an overcharge detection circuit that outputs a charge abnormality detection signal by detecting an overdischarge of the cell 200A, when a cell voltage greater than or equal to a predetermined first overcharge detection threshold value is detected with respect to the cell 200A. On the other hand, the detection circuit 21B forms an overcharge detection circuit that outputs a charge abnormality detection signal by detecting an overdischarge of the cell 200B, when a cell voltage greater than or equal to a predetermined second overcharge detection threshold value is detected with respect to the cell 200B.

In addition, the detection circuit 21A forms an overdischarge detection circuit that outputs a discharge abnormality detection signal by detecting an overdischarge of the cell 200A, when a cell voltage less than or equal to a predetermined first overdischarge detection threshold value is detected with respect to the cell 200A. On the other hand, the detection circuit 21B forms an overdischarge detection circuit that outputs a discharge abnormality detection signal by detecting an overdischarge of the cell 200B, when a cell voltage less than or equal to a predetermined second overdischarge detection threshold value is detected with respect to the cell 200B.

Further, the detection circuit 21A forms a charge overcurrent detection circuit that outputs a charge abnormality detection signal by detecting an overcurrent (charge overcurrent) in the charge direction of the cell 200A, when the negative terminal voltage VAP− less than or equal to a predetermined first charge overcurrent detection threshold value is detected. On the other hand, the detection circuit 21B forms a charge overcurrent detection circuit that outputs a charge abnormality detection signal by detecting an overcurrent (charge overcurrent) in the charge direction of the cell 200B, when the negative terminal voltage VBP− less than or equal to a predetermined second charge overcurrent detection threshold value is detected.

In the state in which at least the transistor 1A is ON, the negative terminal voltage VAP− decreases when the charge current to charge the cell 200A flows, because a voltage drop is generated by an ON-resistance of the transistor 1A. In addition, when the transistor 2A is ON, the negative terminal voltage VAP− decreases due to a voltage drop caused by an ON-resistance of the transistor 2A. When the transistor 2 is OFF, the negative terminal voltage VAP− decreases due to a voltage drop caused by the parasitic diode of the transistor 2. The negative terminal voltage VBP− undergoes a change similar to that described above.

Moreover, the detection circuit 21 forms a discharge overcurrent detection circuit that outputs a discharge abnormality detection signal by detecting an overcurrent (discharge overcurrent) in the discharge direction of the cell 200A, when the negative terminal voltage VAP− greater than or equal to a predetermined first discharge overcurrent detection threshold value is detected. On the other hand, the detection circuit 21B forms a discharge overcurrent detection circuit that outputs a discharge abnormality detection signal by detecting an overcurrent (discharge overcurrent) in the discharge direction of the cell 200B, when the negative terminal voltage VBP− greater than or equal to a predetermined second discharge overcurrent detection threshold value is detected.

In the state in which at least the transistor 2A is ON, the negative terminal voltage VAP− increases when the discharge current to discharge the cell 200A flows, because a voltage rise is generated by the ON-resistance of the transistor 2A. In addition, when the transistor 1A is ON, the negative terminal voltage VAP− increases due to a voltage rise caused by the ON-resistance of the transistor 1A. When the transistor 1A is OFF, the negative terminal voltage VAP− increases due to a voltage rise caused by the parasitic diode of the transistor 1A. The negative terminal voltage VBP− undergoes a change similar to that described above.

A discharge control circuit 24 of the protection IC 90 turns OFF the transistor 2A by outputting a low-level signal from the terminal DOUT1 of the protection IC 90A. Hence, the cell 200A may be protected from the overdischarge or the discharge overcurrent, regardless of the ON state or the OFF state of the transistor 1A. Similarly, the discharge control circuit 24 turns OFF the transistor 2B by outputting a low-level signal from the terminal DOUT2 of the protection IC 90B. Thus, the cell 200B may be protected from the overdischarge or the discharge overcurrent, regardless of the ON state or the OFF state of the transistor 1B.

For example, the discharge control circuit 24 turns OFF at least one of the transistors 2A and 2B, when the discharge abnormality detection signal is output from at least one of the discharge overcurrent detection circuits of the detection circuits 21A and 21B. In addition, the discharge control circuit 24 turns OFF at least one of the transistors 2A and 2B, when the discharge abnormality detection signal is output from at least one of the overdischarge detection circuits of the detection circuits 21A and 21B. Moreover, the discharge control circuit 24 may, for example, turn OFF at least one of the transistors 2A and 2B, when the discharge abnormality detection signal is output from at least one of the discharge overcurrent detection circuits and the overdischarge detection circuits of the detection circuits 21A and 21B.

For example, the discharge control circuit 24 may preferably turn OFF both the transistors 2A and 2B by obtaining a logical sum of the discharge abnormality detection signals from each of the detection circuits. In this case, the discharge of both the cells 200A and 200B may be prohibited, even when the discharge abnormality is generated in only one of the cells 200A and 200B. As a result, the discharge of not only the cell from which the discharge abnormality is detected, but also the discharge of the normal cell, may be prohibited.

In addition, the discharge control circuit 24 may turn OFF both the transistors 2A and 2B by obtaining a logical product of the discharge abnormality detection signals from each of the detection circuits, for example. In this case, the discharge of both the cells 200A and 200B may be prohibited when the discharge abnormality is generated in all of the cells 200A and 200B. As a result, even when the discharge abnormality is detected from a cell, the discharge of the normal cell may be permitted.

Furthermore, the discharge control circuit 24 may turn OFF only one of the transistors 2A and 2B that blocks the discharge route of the cell from which the discharge abnormality is detected by the detection circuit, for example. In this case, the discharge of only one of the cells 200A and 200B from which the discharge abnormality is detected may be prohibited.

On the other hand, the charge control circuit 25 of the protection IC 90 turns OFF the transistor 1A by outputting a low-level signal from the terminal COUT1 of the protection IC 90A. Hence, the cell 200A may be protected from the overcharge or the charge overcurrent, regardless of the ON state or the OFF state of the transistor 2A. Similarly, the discharge control circuit 24 turns OFF the transistor 1B by outputting a low-level signal from the terminal COUT2 of the protection IC 90B. Thus, the cell 200B may be protected from the overcharge or the charge overcurrent, regardless of the ON state or the OFF state of the transistor 2B.

For example, the charge control circuit 25 turns OFF at least one of the transistors 1A and 1B, when the charge abnormality detection signal is output from at least one of the charge overcurrent detection circuits of the detection circuits 21A and 21B. In addition, the charge control circuit 25 turns OFF at least one of the transistors 1A and 1B, when the charge abnormality detection signal is output from at least one of the overcharge detection circuits of the detection circuits 21A and 21B. Further, the charge control circuit 25 may, for example, turn OFF at least one of the transistors 1A and 1B, when the charge abnormality detection signal is output from at least one of the charge overcurrent detection circuit and the overcharge detection circuits of the detection circuits 21A and 21B.

For example, the charge control circuit 25 may preferably turn OFF both the transistors 1A and 1B by obtaining a logical sum of the charge abnormality detection signals from each of the detection circuits. In this case, the charge of both the cells 200A and 200B may be prohibited, even when the charge abnormality is generated in only one of the cells 200A and 200B. As a result, the charge of not only the cell from which the charge abnormality is detected, but also the charge of the normal cell, may be prohibited.

In addition, the charge control circuit 25 may turn OFF both the transistors 1A and 1B by obtaining a logical product of the charge abnormality detection signals from each of the detection circuits, for example. In this case, the charge of both the cells 200A and 200B may be prohibited when the charge abnormality is generated in all of the cells 200A and 200B. As a result, even when the charge abnormality is detected from a cell, the charge of the normal cell may be permitted.

Furthermore, the charge control circuit 25 may turn OFF only one of the transistors 1A and 1B that blocks the charge route of the cell from which the charge abnormality is detected by the detection circuit, for example. In this case, the charge of only one of the cells 200A and 200B from which the charge abnormality is detected may be prohibited.

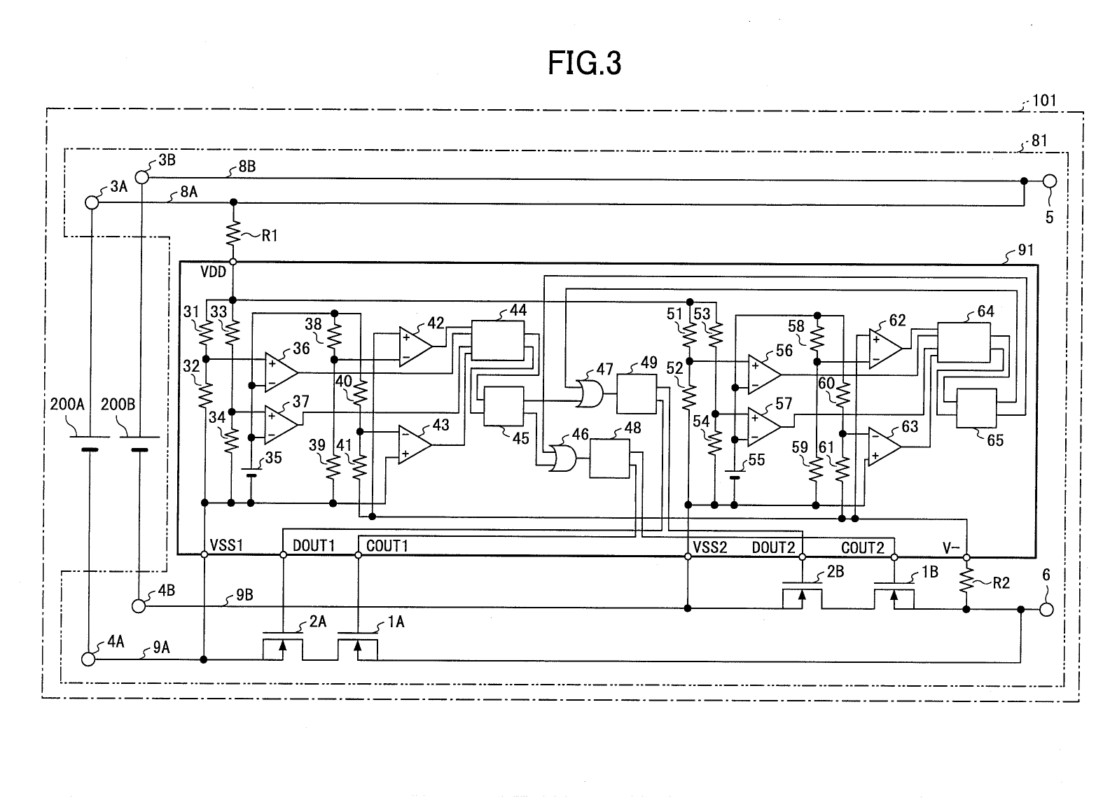

FIG. 3 is a diagram illustrating the structure of the battery pack 101 in the second embodiment of the present invention. A description of the structure similar to that of the above described embodiment will be omitted. The battery pack 101 includes a secondary battery 20, and a protection module 81 to protect the secondary battery 200. The protection module 81 includes a protection IC 91. The protection IC 91 is formed by a single chip.

The protection IC 91 includes an overcharge detection circuit, an overdischarge detection circuit, a charge overcurrent detection circuit, and a discharge overcurrent detection circuit.

The overcharge detection circuit to detect the overcharge of the cell 200A includes a voltage divider that includes resistors 31 and 32, and a comparator 36. The voltage divider divides a power supply voltage VDD1, which is a potential difference between the terminal VSS1 and the terminal VDD. The comparator 36 operates at the power supply voltage VDD1, and includes a non-inverting input terminal that receives a divided voltage VD1 from the voltage divider, and an inverting input terminal that receives a reference voltage VREF1 generated from a reference voltage generating circuit 35. Accordingly, the overcharge detection circuit for the cell 200A outputs a high-level signal (charge abnormality detection signal) to prohibit the charge of the cell 200A when the divided voltage VD1 exceeds the reference voltage VREF1, and outputs a low-level signal to permit the charge of the cell 200A when the divided voltage VD1 does not exceed the reference voltage VREF1.

The overcharge detection circuit to detect the overcharge of the cell 200B includes a voltage divider that includes resistors 51 and 52, and a comparator 56. The voltage divider divides a power supply voltage VDD2, which is a potential difference between the terminal VSS2 and the terminal VDD. The comparator 56 operates at the power supply voltage VDD2, and includes a non-inverting input terminal that receives a divided voltage VD2 from the voltage divider, and an inverting input terminal that receives a reference voltage VREF2 generated from a reference voltage generating circuit 55. Accordingly, the overcharge detection circuit for the cell 200B outputs a high-level signal (charge abnormality detection signal) to prohibit the charge of the cell 200B when the divided voltage VD2 exceeds the reference voltage VREF2, and outputs a low-level signal to permit the charge of the cell 200B when the divided voltage VD2 does not exceed the reference voltage VREF2.

The overdischarge detection circuit to detect the overdischarge of the cell 200A includes a voltage divider that includes resistors 33 and 34, and a comparator 37. The voltage divider divides the power supply voltage VDD1. The comparator 37 operates at the power supply voltage VDD1, and includes a non-inverting input terminal that receives a divided voltage VD3 from the voltage divider, and an inverting input terminal that receives the reference voltage VREF1 generated from the reference voltage generating circuit 35. Accordingly, the overdischarge detection circuit for the cell 200A outputs a high-level signal (discharge abnormality detection signal) to prohibit the discharge of the cell 200A when the divided voltage VD3 exceeds the reference voltage VREF1, and outputs a low-level signal to permit the discharge of the cell 200A when the divided voltage VD3 does not exceed the reference voltage VREF1.

The overdischarge detection circuit to detect the overdischarge of the cell 200B includes a voltage divider that includes resistors 53 and 54, and a comparator 57. The voltage divider divides the power supply voltage VDD2. The comparator 57 operates at the power supply voltage VDD2, and includes a non-inverting input terminal that receives a divided voltage VD4 from the voltage divider, and an inverting input terminal that receives the reference voltage VREF2 generated from the reference voltage generating circuit 55. Accordingly, the overdischarge detection circuit for the cell 200B outputs a high-level signal (discharge abnormality detection signal) to prohibit the discharge of the cell 200B when the divided voltage VD4 exceeds the reference voltage VREF2, and outputs a low-level signal to permit the discharge of the cell 200B when the divided voltage VD4 does not exceed the reference voltage VREF2.

The discharge overcurrent detection circuit to detect the discharge overcurrent of the cell 200A includes a voltage divider that includes resistors 38 and 39, and a comparator 42. The voltage divider divides a potential difference between the reference voltage VREF1 and the terminal voltage VSS1. The comparator 42 operates at the power supply voltage VDD1, and includes a non-inverting input terminal that receives a divided voltage VD5 from the voltage divider, and an inverting input terminal that receives a terminal voltage V−. Accordingly, the discharge overcurrent detection circuit for the cell 200A outputs a high-level signal (discharge abnormality detection signal) to prohibit the discharge of the cell 200A when the terminal voltage V− exceeds the divided voltage VD5, and outputs a low-level signal to permit the charge of the cell 200A when the terminal voltage V− does not exceed the divided voltage VD5.

The discharge overcurrent detection circuit to detect the overcharge of the cell 200B includes a voltage divider that includes resistors 58 and 59, and a comparator 62. The voltage divider divides a potential difference between the reference voltage VREF2 and the terminal voltage VSS2. The comparator 62 operates at the power supply voltage VDD2, and includes a non-inverting input terminal that receives a divided voltage VD6 from the voltage divider, and an inverting input terminal that receives the terminal voltage V−. Accordingly, the discharge overcurrent detection circuit for the cell 200B outputs a high-level signal (discharge abnormality detection signal) to prohibit the discharge of the cell 200B when the terminal voltage V− exceeds the divided voltage VD6, and outputs a low-level signal to permit the discharge of the cell 200B when the terminal voltage V− does not exceed the divided voltage VD6.

The charge overcurrent detection circuit to detect the charge overcurrent of the cell 200A includes a voltage divider that includes resistors 40 and 41, and a comparator 43. The voltage divider divides a potential difference between the reference voltage VREF1 and the terminal voltage V−. The comparator 43 operates at the power supply voltage VDD1, and includes a non-inverting input terminal that receives a divided voltage VD7 from the voltage divider, and an inverting input terminal that receives the terminal voltage VSS1. Accordingly, the charge overcurrent detection circuit for the cell 200A outputs a high-level signal (charge abnormality detection signal) to prohibit the charge of the cell 200A when the terminal voltage VSS1 exceeds the divided voltage VD7, and outputs a low-level signal to permit the charge of the cell 200A when the terminal voltage VSS1 does not exceed the divided voltage VD7.

The charge overcurrent detection circuit to detect the overcharge of the cell 200B includes a voltage divider that includes resistors 60 and 61, and a comparator 63. The voltage divider divides a potential difference between the reference voltage VREF2 and the terminal voltage V−. The comparator 63 operates at the power supply voltage VDD2, and includes a non-inverting input terminal that receives a divided voltage VD8 from the voltage divider, and an inverting input terminal that receives the terminal voltage VSS2. Accordingly, the charge overcurrent detection circuit for the cell 200B outputs a high-level signal (charge abnormality detection signal) to prohibit the charge of the cell 200B when the terminal voltage VSS2 exceeds the divided voltage VD8, and outputs a low-level signal to permit the charge of the cell 200B when the terminal voltage VDD2 does not exceed the divided voltage VD8.

The plurality of positive power terminals (terminal VDD1 and terminal VDD2) are provided in FIG. 2 because the protection IC 90 is formed by a plurality of chips. On the other hand, a single common positive power terminal (terminal VDD) may be provided in FIG. 3 because the protection IC 91 is formed by a single chip. The terminal VDD is connected to the power supply route 8A via the resistor R1 in the example illustrated in FIG. 3, however, the terminal VDD may be connected to the power supply route 8B via the resistor R1.

Similarly, the plurality of overcurrent detection terminals (terminal V-1 and terminal V-2) are provided in FIG. 2 because the protection IC 90 is formed by a plurality of chips. On the other hand, a single common overcurrent detection terminal (terminal V−) may be provided in FIG. 3 because the protection IC 91 is formed by a single chip. The terminal V− is connected to the power supply route 9B via the resistor R2, between the load connecting terminal 6 and the transistors 1B and 1B, in the example illustrated in FIG. 3, however, the terminal V− may be connected to the power supply route 9A via the resistor R2, between the load connecting terminal 6 and the transistors 1A and 2A.

A logic circuit 44 includes a logical sum circuit that outputs a charge abnormality detection signal indicating a generation of a charge abnormality in the cell 200A, by obtaining a logical sum of an output signal of the comparator 36 and an output signal of the comparator 43. The logic circuit 44 also includes a logical sum circuit that outputs a discharge abnormality detection signal indicating a generation of a discharge abnormality in the cell 200A, by obtaining a logical sum of an output signal of the comparator 37 and an output signal of the comparator 42. The logic circuit 44 operates at the power supply voltage VDD1, which is the potential difference between the terminal VSS1 and the terminal VDD.

Similarly, a logic circuit 64 includes a logical sum circuit that outputs a charge abnormality detection signal indicating a generation of a charge abnormality in the cell 200B, by obtaining a logical sum of an output signal of the comparator 56 and an output signal of the comparator 63. The logic circuit 64 also includes a logical sum circuit that outputs a discharge abnormality detection signal indicating a generation of a discharge abnormality in the cell 200B, by obtaining a logical sum of an output signal of the comparator 57 and an output signal of the comparator 62. The logic circuit 64 operates at the power supply voltage VDD2, which is the potential difference between the terminal VSS2 and the terminal VDD.

A level shift circuit 45 folds back by a transistor the charge abnormality detection signal generated by the logic circuit 44 using VSS1 as the reference, in order to perform a level-shift thereon and obtain the charge abnormality detection signal having VDD as the reference. The level shift circuit 45 folds back by a transistor the discharge abnormality detection signal generated by the logic circuit 44 using VSS1 as the reference, in order to perform a level-shift thereon and obtain the discharge abnormality detection signal having VDD as the reference. Similarly, a level shift circuit 65 folds back by a transistor the charge abnormality detection signal generated by the logic circuit 64 using VSS2 as the reference, in order to perform a level-shift thereon and obtain the charge abnormality detection signal having VDD as the reference. The level shift circuit 65 folds back by a transistor the discharge abnormality detection signal generated by the logic circuit 64 using VSS2 as the reference, in order to perform a level-shift thereon and obtain the discharge abnormality detection signal having VDD as the reference. The level shift circuits 45 and 65 may convert abnormality detection signals generated using different potential references into abnormality detection signals generated using a common potential reference.

A logical sum circuit 46 outputs a logical sum signal of the charge abnormality detection signal output from the level shift circuit 45 and the charge abnormality detection signal output from the level shift circuit 65. A logical sum circuit 47 outputs a logical sum signal of the discharge abnormality detection signal output from the level shift circuit 45 and the discharge abnormality detection signal output from the level shift circuit 65.

A level shift circuit 48 folds back by a transistor the logical sum signal output from the logical sum circuit 46, in order to perform a level-shift thereon and obtain a gate driving signal having V− as the reference, so that the transistors 1A and 1B may be positively turned ON or OFF. On the other hand, the level shift circuit 49 folds back by a transistor the logical sum signal output from the logical sum circuit 47, in order to perforin a level-shift thereon and obtain a gate driving signal having VSS1 as the reference, so that the transistor 2A may be positively turned ON or OFF. In addition, a level shift circuit 49 folds back by a transistor the logical sum signal output from the logical sum circuit 47, in order to perform a level-shift thereon and obtain a gate driving signal having VSS2 as the reference, so that the transistor 2B may be positively turned ON or OFF.

According to the structure described above, the charge of both the cells 200A and 200B may be prohibited, even when the charge abnormality is generated in only one of the cells 200A and 200B. As a result, the charge of not only the cell from which the charge abnormality is detected, but also the charge of the normal cell, may be prohibited. In addition, the discharge of both the cells 200A and 200B may be prohibited, even when the discharge abnormality is generated in only one of the cells 200A and 200B. As a result, the discharge of not only the cell from which the discharge abnormality is detected, but also the discharge of the normal cell, may be prohibited.

According to each of the embodiments described above, the function of protecting the plurality of secondary batteries connected in parallel may be improved.

Although the present invention is described with reference to preferable embodiments, the present invention is not limited to the described embodiments, and various variations, modifications, and substitutions may be made in the embodiments without departing from the scope of the present invention.

For example, although the secondary battery 200 includes two cells connected in parallel in the example described above, three or more cells may be connected in parallel. In addition, the illustrated locations where the transistor 1A and 2A are arranged may be mutually substituted or interchanged. Further, the illustrated locations where the transistors 1B and 2B are arranged may be mutually substituted or interchanged.

In the embodiments described above, the transistors 1A and 1B to control the charge and the transistors 2A and 2B to control the discharge are inserted in the negative side power supply routes 9A and 9B, and the overcurrent detection terminals (terminal V-1, terminal V-2, terminal V−) are connected to the negative side power supply routes 9A and 9B. However, the transistors to control the charge and the transistors to control the discharge may be inserted in the positive side power supply routes, and the overcurrent detection terminals may be connected to the positive side power supply routes. In this case, an overcurrent detection part may monitor a voltage between the overcurrent detection terminal and the positive power terminal connected to the positive side power supply route, in order to detect the discharge overcurrent or the charge overcurrent.

In addition, in FIG. 2, one or both of the discharge control circuit 24 and the charge control circuit 25 may not be provided on the same chip as the detection circuit 21A or 21B, and may be externally connected to the protection IC 90.

Moreover, in FIG. 3, one or both of the logical sum circuits 46 and 47 may be modified to a logical product circuit. In this case, the charge of both of the cells 200A and 200B may be prohibited when the charge abnormality is detected from all of the cells 200A and 200B. As a result, even when the charge abnormality is detected from a cell, the charge of the normal cell may be permitted. Furthermore, the discharge of both of the cells 200A and 200B may be prohibited when the discharge abnormality is detected from all of the cells 200A and 200B. As a result, even when the discharge abnormality is detected from a cell, the discharge of the normal cell may be permitted.

1. A battery protection circuit configured to protect a plurality of secondary batteries coupled in parallel, comprising:
an overdischarge detection part, provided for each of the plurality of secondary batteries, and configured to output an abnormality signal when an overdischarge is detected from a corresponding one of the plurality of secondary batteries;
an overcurrent detection part, provided for each of the plurality of secondary batteries, and configured to output an abnormality signal when an overcurrent is detected from a corresponding one of the plurality of secondary batteries; and
a discharge control part configured to prohibit a discharge of at least one of the plurality of secondary batteries when the abnormality signal is output from at least one of the overdischarge detection part and the overcurrent detection part.

2. The battery protection circuit as claimed in claim 1, comprising:
an overcharge detection part, provided for each of the plurality of secondary batteries, and configured to output an abnormality signal when an overcharge is detected from a corresponding one of the plurality of secondary batteries; and
a charge control part configured to prohibit a charge of at least one of the plurality of secondary batteries when the abnormality signal is output from at least one of the overcharge detection part and the overcurrent detection part.

3. The battery protection circuit as claimed in claim 1, wherein the discharge control part prohibits the discharge of all of the plurality of secondary batteries when the abnormality signal is output from at least one of the overdischarge detection part and the overcurrent detection part.

4. The battery protection circuit as claimed in claim 1, wherein the discharge control part prohibits only a secondary battery related to the abnormality signal when the abnormality signal is output from at least one of the overdischarge detection part and the overcurrent detection part.

5. A battery protection circuit configured to protect a plurality of secondary batteries coupled in parallel, comprising:
an overcharge detection part, provided for each of the plurality of secondary batteries, and configured to output an abnormality signal when an overcharge is detected from a corresponding one of the plurality of secondary batteries;
an overcurrent detection part, provided for each of the plurality of secondary batteries, and configured to output an abnormality signal when an overcurrent is detected from a corresponding one of the plurality of secondary batteries; and
a charge control part configured to prohibit a charge of at least one of the plurality of secondary batteries when the abnormality signal is output from at least one of the overcharge detection part and the overcurrent detection part.

6. The battery protection circuit as claimed in claim 5, wherein the charge control part prohibits the charge of all of the plurality of secondary batteries when the abnormality signal is output from at least one of the overcharge detection part and the overcurrent detection part.

7. The battery protection circuit as claimed in claim 5, wherein the charge control part prohibits the charge of only a secondary battery related to the abnormality signal when the abnormality signal is output from at least one of the overcharge detection part and the overcurrent detection part.

8. The battery protection circuit as claimed in claim 1, wherein the overcurrent detection part comprises:
a charge overcurrent detection part, provided for each of the plurality of secondary batteries, and configured to output an abnormality signal when a charge overcurrent is detected from a corresponding one of the plurality of secondary batteries; and
a discharge overcurrent detection part, provided for each of the plurality of secondary batteries, and configured to output an abnormality signal when a discharge overcurrent is detected from a corresponding one of the plurality of secondary batteries.

9. The battery protection circuit as claimed in claim 1,
wherein the battery protection circuit is formed on a single chip, and
wherein the overcurrent detection part monitors a voltage between a power terminal and an overcurrent detection terminal that is common to the overcurrent detection part provided for each of the plurality of secondary batteries.

10. A battery protection circuit configured to protect a plurality of secondary batteries coupled in parallel, comprising:
a plurality of discharge overcurrent detection parts, respectively provided for the plurality of secondary batteries, and each configured to output an abnormality signal when a discharge overcurrent is detected from a corresponding one of the plurality of secondary batteries; and
a discharge control part configured to prohibit a discharge of all of the plurality of secondary batteries when the abnormality signal is output from at least one of the plurality of discharge overcurrent detection parts.

11. A battery protection circuit configured to protect a plurality of secondary batteries coupled in parallel, comprising:
a plurality of overdischarge detection parts, respectively provided for the plurality of secondary batteries, and each configured to output an abnormality signal when an overdischarge is detected from a corresponding one of the plurality of secondary batteries; and
a discharge control part configured to prohibit a discharge of all of the plurality of secondary batteries when the abnormality signal is output from at least one of the plurality of overdischarge detection parts.

12. A battery protection circuit configured to protect a plurality of secondary batteries coupled in parallel, comprising:
a plurality of charge overcurrent detection parts, respectively provided for the plurality of secondary batteries, and each configured to output an abnormality signal when a charge overcurrent is detected from a corresponding one of the plurality of secondary batteries; and
a charge control part configured to prohibit a charge of all of the plurality of secondary batteries when the abnormality signal is output from at least one of the plurality of charge overcurrent detection parts.

13. A battery protection circuit configured to protect a plurality of secondary batteries coupled in parallel, comprising:
a plurality of overcharge detection parts, respectively provided for the plurality of secondary batteries, and each configured to output an abnormality signal when an overcharge is detected from a corresponding one of the plurality of secondary batteries; and
a charge control part configured to prohibit a charge of all of the plurality of secondary batteries when the abnormality signal is output from at least one of the plurality of overcharge detection parts.

14. A battery protection device comprising:
a battery protection circuit as claimed in claim 1; and
a discharge route blocking part configured to block a discharge route of a secondary battery whose discharge is prohibited by the discharge control part.

15. A battery protection device comprising:
a battery protection circuit as claimed in claim 5; and
a charge route blocking part configured to block a charge route of a secondary battery whose charge is prohibited by the charge control part.

16. A battery pack comprising:
a battery protection device as claimed in claim 14; and
the plurality of secondary batteries.

17. A battery pack comprising:
a battery protection device as claimed in claim 15; and
the plurality of secondary batteries.
